(19) United States
(12) Patent Application Publication
(10) Pub. No.: US 2007/0075169 A1
(43) Pub. Date: Apr. 5, 2007

(54) Waste food disposal unit

(75) Inventors: Ji Cheng Pan, Shenzhen (CN); Allan Wai Lun Kwan, Hong Kong (CN); Bao Ting Liu, Shenzhen (CN)

Correspondence Address: BIRCH STEWART KOLASCH & BIRCH, PO BOX 747, FALLS CHURCH, VA, 22040-0747, US

(73) Assignee: Johnson Electric S.A.

(21) Appl. No.: 11/528,315

(22) Filed: Sep. 28, 2006

(30) Foreign Application Priority Data
Sep. 30, 2005 (CN) 200510119970.4

(51) Int. Cl. B02C 23/36

(52) U.S. Cl. 241/46.013

(57) ABSTRACT

A waste food disposer unit for under sink application has a housing divided into a grinding chamber and a motor chamber. The grinding chamber has an inlet for water and waste matter and an outlet for water and shredded waste matter. A shredder ring 20 is disposed within the grinding chamber and has a plurality of cutting teeth formed by slots extending upwardly from a lower edge of the ring. A grinding disc is disposed within the ring and co-acts with the cutting teeth to shred the waste matter. The grinding disc is connected to the shaft of a motor by amounting bracket. The grinding disc may be conical forming an angle with a normal axis of between 75° and 85°. The mounting plate preferably mounts the grinding disc so that the axis of the shaft is misaligned with the normal axis of the grinding disc by a few degrees, i.e., between 3° and 70°, especially 5°, giving the shredding action between the shredder ring and the grinding disc a sawing or axial movement component.

### CROSS-REFERENCE TO RELATED APPLICATIONS

This non-provisional patent application claims priority under 35 U.S.C. § 119(a) from patent application Ser. No. 200510119970.4 filed in China on Sep. 30, 2005.

### FIELD OF THE INVENTION

This invention relates to a waste disposal unit.

### BACKGROUND

Waste food disposers, especially those designed for domestic use, are often installed under a sink where they are directly attached to the drain of the sink. As such, the disposer takes up considerable storage space under the sink.

The axial length of the disposer has already been shortened to reduce the space taken and the long thin designs of early disposers has been replaced by shorter fatter designs. The volume of the grinding chamber needs to be sufficiently large to quickly drain the sink when the plug is removed. It also needs a certain volume to effect efficient grinding of waste material. The size of the motor has been modified to be axially short with a larger diameter to achieve the driving torque and with the larger diameter grinding disc, giving higher disc tip speed to give quick grinding. However, there is still a desire for a smaller and/or a more efficient waste disposal unit.

The present invention in one aspect thereof allows a smaller axial length by moving the motor closer to the grinding chamber. In another aspect, the present invention achieves a more efficient disposal unit by introducing an axial component to the shredding action of the grinding mechanism.

### SUMMARY OF THE INVENTION

Accordingly, the present invention provides a waste food disposer comprising: a housing defining a grinding chamber having an inlet and an outlet and a grinding mechanism disposed within the housing including: a shredder ring; a grinding disc; a motor, for rotating the grinding disc and having an output shaft; and a mounting bracket for fixing the grinding disc to the output shaft, characterised in that the grinding disc is conical with the outer periphery of the grinding disc disposed closer to motor than the center of the grinding disc.

Preferably, the angle of the grinding disc with respect to a normal axis of the grinding disc is between 75° to 85°, especially 80°.

Optionally, the mounting bracket fixes the grinding disc to the output shaft with a normal axis of the grinding disc co-axial with the output shaft.

Alternatively, the mounting bracket fixes the grinding disc to the output shaft with a normal axis of the grinding disc angularly offset to the output shaft.

Preferably, the angular offset between the normal axis of the grinding disc and the shaft is between 3° and 7°, especially 5°.

Optionally, the grinding disc has peripheral teeth formed by a plurality of recesses spaced about a radially outer periphery of the grinding disc.

Preferably, the grinding disc has a fixed pusher.

Optionally, the grinding disc has at least one swivel pusher.

Optionally, the shredder ring is stepped.

Preferably, the shredder ring has a plurality of inwardly projecting fingers to prevent riding.

According to a second aspect, the present invention provides a waste food disposer, comprising: a housing defining a grinding chamber having an inlet and an outlet, and a motor chamber separated from the grinding chamber by a divider; and a grinding mechanism disposed within the housing including: a shredder ring located in the grinding chamber; a grinding disc disposed within and co-acting with the shredder ring; a motor accommodated within the motor chamber and having an output shaft; and a motor bracket fixing the grinding disc to the output shaft for rotation therewith, characterized in that the mounting bracket fixes the grinding disc to the output shaft such that a normal axis of the grinding disc is angularly offset from a longitudinal axis of the output shaft.

Preferably, the angle of offset between the grinding disc and the output shaft is between 3° and 7°, especially 5°.

According to a third aspect, the present invention provides a shredder ring for a food disposer, comprising a ring of metal having a plurality of slots open at a lower edge of the ring and extending towards the upper edge at an angle to the vertical such that the slots form teeth extending downwardly and in the direction of rotation of a grinding disc.

Optionally, the angle is between 20° and 30° to the vertical.

Preferably, the shredder ring has a plurality of inwardly directed fingers spaced circumferentially and located axially above the slots.

Optionally, the shredder ring has at least two inwardly directly fingers located between a respective pair of adjacent slots.

### BRIEF DESCRIPTION OF THE DRAWINGS

Preferred embodiments of the invention will now be described, by way of example only, in which:

FIG. 1 is a sectional schematic view of a waste food disposer according to the present invention;

FIG. 2 is an exploded representation of the working parts of the disposer of FIG. 1;

FIG. 3 is a sectional view of a grinding disc of the disposer of FIG. 1;

FIG. 4 is an elevational view of a bracket for mounting the disc of FIG. 3; and

FIG. 5 is a sectional view of the grinding mechanism for a second embodiment.

### DETAILED DESCRIPTION OF THE PREFERRED EMBODIMENTS

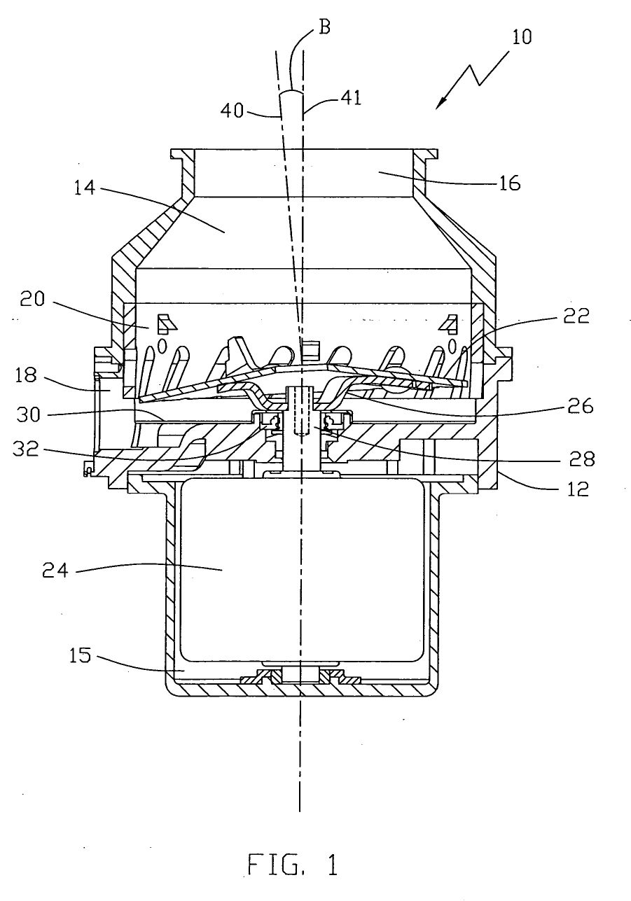

The preferred waste food disposer, as shown in FIG. 1, has a housing 12 defining a grinding chamber 14, having an inlet 16 and an outlet 18. The inlet 16 is adapted to be fixed to the drain of a sink and the outlet is connected, in use, to a drain pipe for the removal of the waste. Located within the grinding chamber is a grinding mechanism including a shredder ring 20 and a grinding disc 22.

The grinding disc 22 is mounted on an output shaft 28 of an electric motor 24 by way of a mounting bracket 26. The motor 24, in this embodiment, is a high voltage DC motor, and is located in a motor compartment 15 of the housing which is separated from the grinding chamber by a divider 30. The output shaft 28 of the motor 24 passes through the divider 30. A seal assembly 32 provides a waterproof rotating connection between the divider 30 and the shaft 28. The divider 30 has an outer periphery which forms part of the housing 12 and the outlet 18.

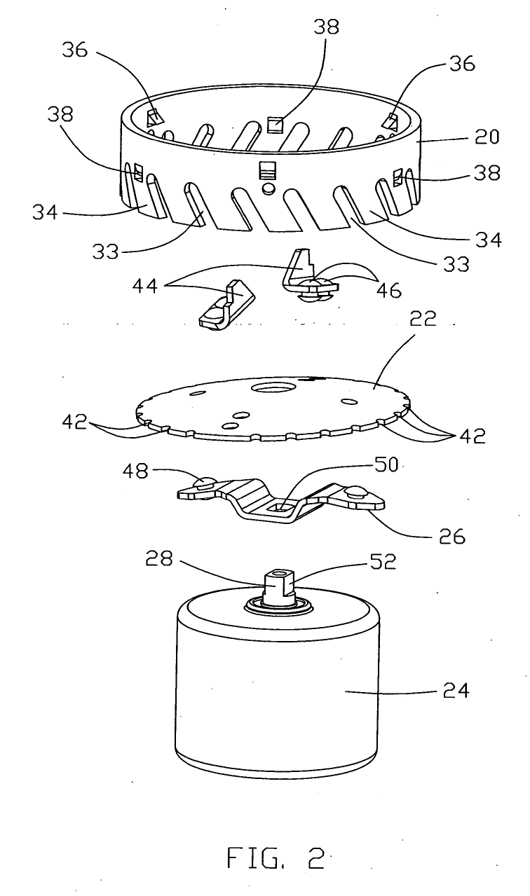

The shredder ring 20 is fixed to the housing 12 within the grinding chamber 14. The shredder ring 20 is more clearly shown in FIG. 2. The shredder ring 20 is a ring of steel, preferably stainless steel and has a plurality of slots 33 extending upwardly from the lower edge of the ring forming large teeth 34. The slots 33 are not vertical but are slanted at an angle between 20° and 30° to the vertical so as to point the teeth 34 downwardly in the direction of rotation of the grinding disc 22 which is disposed, in use, within the shredder ring 20 and axially aligned with the teeth 34. The shredder ring 20 has a number of inwardly projecting fingers 36 located in the unslotted or upper portion of the shredder ring. In this embodiment, there are three fingers 36. The shredder ring 20 also has a number of inwardly projecting fingers 38 located in the slotted or lower portion of the ring, being formed in a respective tooth 34. Fingers 36 and fingers 38 help with the grinding process as will be described later.

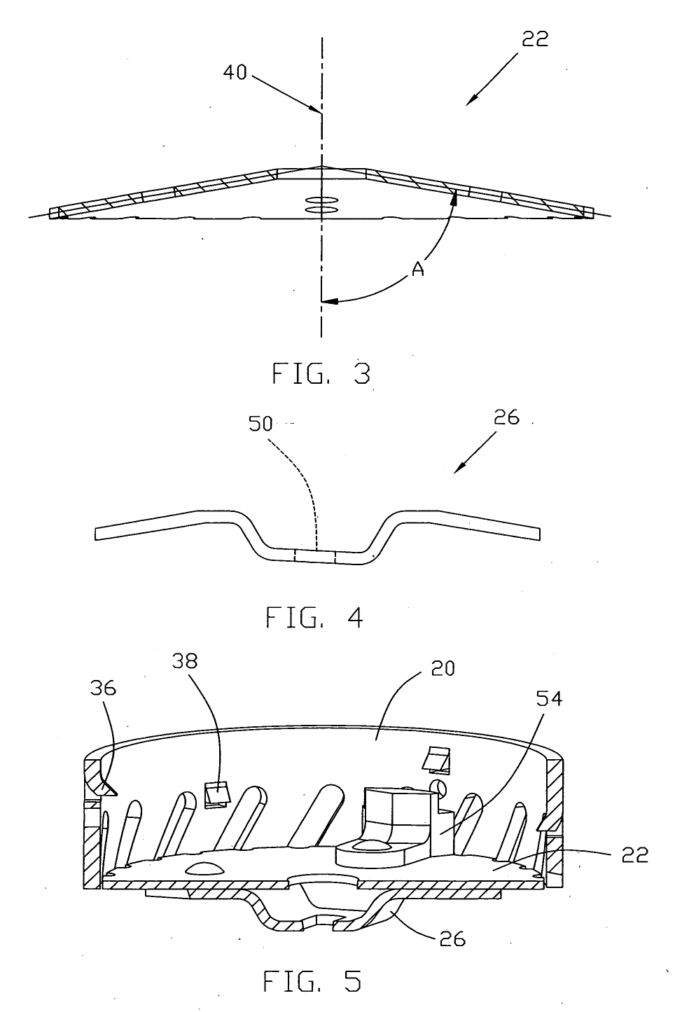

The grinding disc 22 is more clearly shown in FIGS. 2 and 3. In FIG. 3, which is a cross sectional view of the grinding disc, we can see that the disc is not flat but is actually a flatish conical shape. From the normal axis 40, the disc slopes from the center downwardly at an angle of about 10°, i.e., with respect to the normal axis 40 of the grinding disc 22, the disc extends at an angle A of 80° extending outwardly and downwardly from the center. This angle need not be exactly 80°, angles in the range 75° to 85° are acceptable. Indeed, flatter angles are acceptable and the disc could be completely flat. However, to impart an axial component to the shredding motion, like a sawing motion, an angle between 75° and 85° is desirable.

The grinding disc 22 has a plurality of peripheral recesses 42 which form teeth for aiding the shredding process. The grinding disc also has a number of pushers 44, two shown in this embodiment. The pushers are fixed to the disc and stand vertically and close to the periphery of the disc to help push the matter to be shredded to the slots 33 in the shredder ring 20. The pushers 44 shown in FIG. 2 are fixed pushers meaning that they are fixed to the grinding disc 22 and cannot move with respect to the grinding disc 22. They are each fixed by two rivets 46.

The mounting bracket 26 is fixed to the grinding disc 22 by rivets 48. The mounting bracket is a stepped bar as shown in FIG. 4 with a non-round hole 50 in the center which mates with and is keyed to the output shaft of the motor. In this embodiment, the output shaft has two flat sides 52. A spacer (not shown) and a screw (not shown) fix the mounting bracket 26 to the output shaft in known manner. The ends of the mounting bracket 26 extend up from the central region and are then bent back to follow the surface of the grinding disc 22.

The mounting bracket 26 may be formed non-symmetrically so that the grinding disc 22 is not perfectly aligned with the output shaft 28. This may be achieved by bending one arm of the bracket more than the other arm. This misalignment is preferably minor resulting in the normal axis 40 of the grinding disc having an angle B with the axis 41 of the output shaft of between 3° to 7°, especially 5° (as shown in FIG. 1).

Referring back to FIG. 1, operation of the waste food disposer will now be described. Water and waste food is led into the grinding chamber 14 via the inlet 16. The water flows through the slots 33 in the shredder ring 20 and through the recesses 42 in the grinding disc to be discharged from the housing 12 via outlet 18. When the motor 24 is switched on, the output shaft 28 rotates the grinding disc at high speed to fling the matter towards the shredder ring and through the slots 33. Small particles of matter will pass through the slots 33 while large particles of matter will be caught and tom between the large teeth 34 of the shredder ring 20 and the recesses 42 on the disc, until the large particles are small enough to pass through the slots 33. The pushers 44 help to fling the matter to the shredder ring 20. The fingers 36 and 38 do some minor shredding of softer matter but are used to stop large particles of matter from riding on the grinding disc and rubbing high on the shredder ring and thus, avoiding being caught by the teeth 34 of the shredder ring.

Seal assembly 32 prevents water and other solutions from passing through the shaft opening in the divider 30 and into the motor chamber 15.

The offset between the output shaft and the normal rotational axis of the grinding disc provides a pumping or wobbling action which increases the shredding efficiency on large particles caught between the teeth 34 and the grinding disc 22 by adding a vertical sawing like motion to the movement.

FIG. 5 shows a flat grinding disc 21, according to another embodiment, where the mounting bracket still gives the offset function. The grinding disc 22 has two swivel pushers 54. Swivel pushers are fixed to the grinding disc 22 for rotation therewith but they can rotate and/or slide about or along the fixing rivet. This has added value when dealing with hard matter such as bones, allowing the impact to be less forceful on the motor and the mounting structure and creating less noise for the user.

The shredder ring itself may be stepped and the pushers either fixed type or swivel type or combination type, partly fixed, partly swivel type, are correspondingly stepped to match the grinding interface and push the waste matter out to slots in the shredder plate.

Waste food disposal units made according to the present invention exhibit a higher shredding efficiency, resulting in lower disposal time giving savings in motor and electricity usage. They may also be axially shorter.

The embodiment described above is given by way of example only and various modifications will be apparent to persons skilled in the art without departing from the scope of the invention as defined in the appended claims.

What is claimed is:

1. A waste food disposer, comprising:
a housing defining a grinding chamber having an inlet and an outlet; and
a grinding mechanism disposed within the housing including:
a shredder ring;
a grinding disc;
a motor, for rotating the grinding disc and having an output shaft; and
a mounting bracket for fixing the grinding disc to the output shaft,
wherein the grinding disc is conical with the outer periphery of the grinding disc disposed closer to motor than the center of the grinding disc.

2. The waste food disposer of claim 1, wherein the angle of the grinding disc with respect to a normal axis of the grinding disc is between 75° to 85°, especially 80°.

3. The waste food disposer of claim 1, wherein the mounting bracket fixes the grinding disc to the output shaft with a normal axis of the grinding disc co-axial with the output shaft.

4. The waste food disposer of claim 1, wherein the mounting bracket fixes the grinding disc to the output shaft with a normal axis of the grinding disc angularly offset to the output shaft.

5. The waste food disposer of claim 4, wherein the angular offset between the normal axis of the grinding disc and the shaft is between 3° and 7°, especially 5°.

6. The waste food disposer of claim 1, wherein the grinding disc has peripheral teeth formed by a plurality of recesses spaced about a radially outer periphery of the grinding disc.

7. The waste food disposer of claim 1, wherein the grinding disc has a fixed pusher.

8. The waste food disposer of claim 1, wherein the grinding disc has at least one swivel pusher.

9. The waste food disposer of claim 8, wherein the shredder ring is stepped.

10. The waste food disposer of claim 9, wherein the at least one swivel pusher is stepped to match the shedder ring.

11. The waste food disposer of claim 1, wherein the shredder ring has a plurality of inwardly projecting fingers to prevent riding.

12. A waste food disposer, comprising:
a housing defining a grinding chamber having an inlet and an outlet, and a motor chamber separated from the grinding chamber by a divider; and a grinding mechanism disposed within the housing including:
a shredder ring located in the grinding chamber;
a grinding disc disposed within and co-acting with the shredder ring;
a motor accommodated within the motor chamber and having an output shaft; and
a motor bracket fixing the grinding disc to the output shaft for rotation therewith,
wherein the mounting bracket fixes the grinding disc to the output shaft such that a normal axis of the grinding disc is angularly offset from a longitudinal axis of the output shaft.

13. The waste food disposer of claim 12, wherein the angle of offset between the grinding disc and the output shaft is between 3° and 7°, especially 5°.

14. A shredder ring for a food disposer, comprising a ring of metal having a plurality of slots open at a lower edge of the ring and extending towards the upper edge at an angle to the vertical such that the slots form teeth extending downwardly and in the direction of rotation of a grinding disc.

15. The shredder ring of claim 14, wherein the angle is between 20° and 30° to the vertical.

16. The shredder ring of claim 14, wherein the shredder ring has a plurality of inwardly directed fingers spaced circumferentially and located axially above the slots.

17. The shredder ring of claim 14, wherein the shredder ring has at least two inwardly directly fingers located between a respective pair of adjacent slots.
